(19) United States
(12) Patent Application Publication
(10) Pub. No.: US 2024/0088514 A1
(43) Pub. Date: Mar. 14, 2024

(54) DEGASSING UNIT AND BATTERY HOUSING

(71) Applicant: MANN+HUMMEL GmbH, Ludwigsburg (DE)

(72) Inventors: Martin PLOPPA, Stuttgart (DE); Marco BATTEZZATI, Aidlingen (DE); Thomas SCHLEIDEN, Oberstenfeld (DE)

(21) Appl. No.: 18/509,304

(22) Filed: Nov. 15, 2023

Related U.S. Application Data
(63) Continuation of application No. PCT/EP2022/063994, filed on May 24, 2022.

(30) Foreign Application Priority Data
Jun. 15, 2021 (DE) 102021115433.2

(51) Int. Cl. H01M 50/342; B32B 7/022; B32B 7/12; B32B 27/06; F16K 17/16; H01M 50/30; H01M 50/308

(52) U.S. Cl. CPC H01M 50/3425; B32B 7/022; B32B 7/12; B32B 27/06; F16K 17/16; H01M 50/308; H01M 50/394; B32B 2307/54; B32B 2307/724; B32B 2307/7265; B32B 2307/7376; B32B 2457/10; H01M 2200/20; H01M 2220/20

(57) ABSTRACT

A degassing unit for a battery housing has a main body to be connected fluid-tightly to a rim of a housing opening of the battery housing. The main body has a gas passage opening. A membrane is connected fluid-tightly to a rim of the main body surrounding the gas passage opening. The membrane is areally stretched across the gas passage opening and closes it. The membrane bursts at a predetermined burst pressure to release the gas passage opening. The membrane is a film composite with at least a first film and a second film arranged on each other. The first film has a cutout covered by the second film so as to surround the cutout. At least one of the first and second films is connected to the rim surrounding the gas passage opening. A battery housing with such a degassing unit is provided.

### CROSS-REFERENCE TO RELATED APPLICATIONS

This application is a continuation application of International Application No. PCT/EP2022/063994 filed on May 24, 2022, which claims the benefit of German Application No. 102021115433.2 filed on Jun. 15, 2021, the entire disclosures of which are incorporated herein by reference for all purposes.

### BACKGROUND

The invention concerns a degassing unit for a battery housing, in particular of a traction battery of a motor vehicle, as well as a battery housing.

Housings for accommodating electronic components such as, for example, battery cells and the like, are usually not completely gas-tightly closed in relation to the environment. On the one hand, a gas exchange between interior and exterior is to be enabled because of temperature fluctuations, for example, by heat being introduced during charging or discharging of battery cells, and, on the other hand, because of naturally occurring air pressure fluctuations, in particular in case of mobile systems. Impermissible mechanical loads of the housing, in particular a bursting or bulging of the housing, can be prevented as a result of the gas exchange. On the other hand, an emergency venting function in case of sudden pressure increase due to failure of the battery cells must be present in particular in case of battery housings.

However, it is likewise important that the ingress of foreign bodies, dirt, and moisture in the form of liquid water is effectively prevented. Therefore, pressure compensation devices are known which comprise semipermeable membranes, for example, of extruded polytetrafluoroethylene (PTFE), which are gas-permeable but liquid-impermeable.

DE 10 2012 022 346 B4 discloses a battery housing comprising a housing which surrounds a housing interior and is provided with a housing opening which is covered by a membrane carrier in the form of a housing cover provided for degassing and for substantially water-tight sealing of the housing interior against ingress of water or other liquids. The housing cover contains a carrier body comprising a gas passage opening, extending continuously between a carrier body inner side and a carrier body outer side, for discharging gases or for pressure compensation. The gas passage opening is completely covered by a semipermeable membrane. The carrier body, the membrane, and the housing are connected air-tightly or gas-tightly such that substantially no water and preferably also no air or no gas can pass through the housing opening into the housing interior.

### SUMMARY

It is an object of the invention to provide a degassing unit for a battery housing, in particular of a traction battery of a motor vehicle, which enables a quick pressure relief in the housing already at a low degassing pressure.

A further object is to provide a battery housing with a degassing unit which enables a quick pressure relief in the housing already at a low degassing pressure.

The aforementioned object is solved according to an aspect of the invention by a degassing unit for a battery housing, in particular of a traction battery of a motor vehicle, with a main body connectable fluid-tightly to a rim of a housing opening of the housing and provided with an outer side and an inner side, wherein the inner side is facing the housing opening, and comprising at least one gas passage opening which is closed by an areally stretched membrane, wherein the membrane is connected fluid-tightly to the main body at a rim surrounding the gas passage opening, wherein the membrane is embodied as a film composite with at least two films arranged on top of each other, wherein a first film of the films in its surface area comprises at least one cutout which is covered, in particular is gas-tightly covered, by a second film of the films so as to surround the at least one cutout, wherein at least one of the two films is connected to the rim of the main body surrounding the gas passage opening.

The further object is solved according to a further aspect of the invention by a battery housing, in particular of a traction battery of a motor vehicle, for accommodating battery cells, which comprises at least one housing wall with a housing opening, wherein the housing opening is closed by a degassing unit.

Beneficial embodiments and advantages of the invention result from the further claims, the description, and the drawing.

According to an aspect of the invention, a degassing unit is proposed for a battery housing, in particular of a traction battery of a motor vehicle, with a main body connectable fluid-tightly to a rim of a housing opening of the housing and provided with an outer side and an inner side, wherein the inner side is facing the housing opening, and comprising at least one gas passage opening which is closed by an areally stretched membrane, wherein the membrane is connected fluid-tightly to the main body at a rim surrounding the gas passage opening. In this context, the membrane is embodied as a film composite with at least two films arranged on top of each other, wherein a first film of the films in its surface area comprises at least one cutout which is covered gas-tightly by a second film of the films so as to surround the at least one cutout. At least one of the two films is connected to the rim of the main body surrounding the gas passage opening. The membrane can burst at a predetermined burst pressure in order to release the gas passage opening. Burst pressure is to be understood herein as a predetermined limit excess pressure between an interior of the housing and the environment which the membrane cannot mechanically withstand anymore and therefore will burst.

For the emergency venting of high-voltage batteries, usually degassing units with permeable PTFE membranes are used. The permeability, which inter alia is a main cost factor of the membrane, is not required for the pure function of the emergency venting of the battery. A membrane which takes on only the burst function can therefore be replaced by a significantly less expensive film with same burst properties in order to discharge the gas volume flow which is released in case of a thermal event due to failure of a battery cell.

However, only a few of the films which are suitable for the burst function can be welded directly to the main body.

According to the invention, as a membrane, a combination of at least two films to a film composite is therefore used as a burst membrane.

The first film as a carrier film comprises in this context a very minimal elongation. The second film comprises, on the other hand, a very large elongation and can burst already at a degassing pressure as minimal as possible. At the degassing pressure, this elongation leads however to a very large stroke movement for which in general no installation space is available. By contact of the second film at housing walls, the desired low degassing pressure would therefore be limited by the installation space. For this reason, the second film is used together with the first film in the film composite, wherein the first film is provided by means of at least one cutout with such a structure that the second film is reinforced in wide ranges and is limited in respect to the elongation.

In this context, the structure of the cutout enables tearing of the second film at a low degassing pressure such that the entire cross section defined by the structure of the cutout is released. In this manner, it is possible to reduce the stroke movement of the second film significantly without increasing the degassing pressure.

The film composite is connected by at least one of the two films to the main body. In this context, the material of the film which is connected to the main body can be selected such that the film can be, for example, welded or glued to the main body. The membrane is preferably arranged at the inner side of the main body which is facing toward the housing opening.

A significant installation space advantage results advantageously. The installation space requirement is lower and, in particular for limited installation spaces, lower degassing pressures without significant stroke movement of the membrane can be achieved in this way.

According to a beneficial embodiment of the degassing unit, the second film can be connected to the first film by a seal so as to surround the at least one cutout. In this manner, the second film can be gas-tightly connected to the first film, for example, by heat fusing. The application of the seal provides an inexpensive type of connection and enables in a flexible manner different geometries of the cutouts.

According to a beneficial embodiment of the degassing unit, a burst pressure at which the membrane releases the gas passage opening can be adjusted by a width and/or a length and/or a cross section of the seal. By changing the size and shape of the seal, the pressure at which the second film is torn off the first film can be adjusted across a wide range. By targeted weakening and/or the shape of the seal, the location at which the seal will tear first can be defined also.

According to a beneficial embodiment of the degassing unit, a burst pressure at which the membrane releases the gas passage opening can be adjusted by shape and size of the at least one cutout of the first film. Also, by the geometry of the at least one cutout of the first film, the burst pressure can be adjusted across a wide range because, in this way, the surface area can be defined where the second film can tear at the most. Also, the elongation range of the second film can be adjusted in this way.

According to a beneficial embodiment of the degassing unit, the second film can be arranged so as to face toward the outer side of the main body. In this way, it is ensured that, in case of an excess pressure in the housing, the second film can stretch beneficially outwardly until a burst criterion is reached and the film tears, for example. Also, a defined tearing off of the second film from the first film in the region of the seal can thus be realized advantageously.

According to a beneficial embodiment of the degassing unit, the second film can be heat-fused, welded or glued to the first film so as to surround the at least one cutout. Depending on materials of the two films, different types of connection for the seal can be advantageously used. By adjusting the suitable parameters for the types of connection, the desired burst pressure can be adjusted in a large range.

According to a beneficial embodiment of the degassing unit, the film of the two films which is connected to the main body can be embodied of a material of the main body, in particular of polypropylene. As an alternative or in addition, the second film can be embodied as a polymer film, in particular as an elastomer film. In principle, also other material pairs can be used for the two films. The second film however should be easily stretchable.

According to a beneficial embodiment of the degassing unit, an adhesive layer can be arranged on one of the two films and glued to the other of the two films and/or to the main body.

In general, a film composite across the whole surface area cannot be welded to the main body due to different material pairs and is therefore expediently glued to the main body. For example, in one embodiment of the film composite membrane, the thus required adhesive film can be provided with the cutout so that cutout and adhesive rim can be realized with the same adhesive film. In any case, one of the two films in a beneficial embodiment can comprise at its inner side an adhesive layer to which the other one of the two films can be glued. By means of an outwardly positioned rim of the film with the adhesive layer, this film can be glued also directly to the main body.

Furthermore, the carrier layer of the adhesive film can be embodied of the material of the main body, for example, polypropylene (PP), in order to enable alternatively a welding of the film composite by means of the outwardly positioned rim of the film directly to the main body.

This enables a higher flexibility in the manufacturing process without effect on the costs of the degassing unit. The reinforcement of the very thin functional layer of the second film by a structured carrier layer of the first film facilitates in addition handling and processing in the mounting process.

According to a beneficial embodiment of the degassing unit, the membrane can be embodied as a film laminate. The film composite can thus be embodied also directly as a laminate, wherein the first film can be laminated onto the second film or the second film laminated onto the first film, depending on which film comprises the adhesive layer required for this.

According to a beneficial embodiment of the degassing unit, the first film can have a larger thickness than the second film, in particular, the second film can have a thickness smaller than 0.2 mm, preferably smaller than 0.05 mm. In this way, advantageously also minimal degassing pressures can be realized.

According to a beneficial embodiment of the degassing unit, the first film can comprise a higher modulus of elasticity than the second film, in particular a modulus of elasticity higher by at least 50%. In particular, the second film can comprise a modulus of elasticity smaller than 1,000 MPa, preferably smaller than 500 MPa. In this way, it can be ensured that the first film comprises the required stiffness in order to carry out only a minimal stroke movement due to the excess pressure in the interior of the housing and the second film is stretched through the cutout toward the outer side at the location of the at least one cutout in the first film.

According to a beneficial embodiment of the degassing unit, the at least one cutout at least in areas can be embodied in a cross shape or rectangular or circular. Such cutout shapes are advantageous in order to carry out a minimal stroke movement of the film composite upon excess pressure in the interior up to the point of tearing of the second film. Two or more different cutout shapes can be combined.

According to a beneficial embodiment of the degassing unit, the first film and the second film can be embodied to be gas-tight. Alternatively, the first film can be embodied to be gas-tight and the second film to be porous. In particular, the second film in this context can be designed as a semipermeable membrane which enables a passage of gaseous media from an environment into the housing and in reverse and prevents the passage of liquid media and/or solids. In this way, the gas exchange between interior and exterior of the housing can be additionally realized which enables natural air pressure fluctuations as well as a pressure compensation at different temperatures.

Non-porous films in the form of polymer films can be used as a gas-impermeable film, for example. Laminated films but also films with vapor-deposited silver can be used in order to ensure the seal-tightness of the housing for intended operation.

All materials which comprise a gas permeability for venting in normal operation and a sufficiently high-water impermeability can be used as a semipermeable film. Polytetrafluoroethylene (PTFE) can be used as a preferred material for the semipermeable film. The semipermeable film can comprise an average pore size which can lie between 0.01 micrometers and 20 micrometers. The porosity can lie preferably at approximately 50%; the mean pore size can preferably amount to approximately 10 micrometers.

According to a beneficial embodiment of the degassing unit, at least one of the two films, in particular the first film, can be connected fixedly to the main body, in particular welded. Advantageously, this film can be embodied of a material which can be connected to the main body, for example, by welding or gluing. Since a film composite is used as a membrane, a material suitable for this purpose can be used as a first film, for example, while a material which comprises the required properties for a good stretchability is used as a material for the second film.

According to a beneficial embodiment of the degassing unit, the gas passage opening can be covered completely by the membrane. Thus, a permanent sealing of the gas passage opening in intended operation of the housing can be achieved. In this way, it can be prevented that dirt particles or moisture can penetrate into the housing and pose a danger to the operation, for example, of a high-voltage battery.

According to a beneficial embodiment of the degassing unit, the membrane can be present at the inner side of the main body. In this manner, the membrane in case of an excess pressure in the housing is pressed initially into its seal seat prior to the second film stretching so much with further increasing inner pressure that it tears.

According to a beneficial embodiment of the degassing unit, a housing seal can be arranged so as to surround the gas passage opening at the inner side of the main body.

The housing seal can be embodied as an axial or radial seal, i.e., in particular be present at an end face (in case of the axial seal) or at a wall surface (in case of the radial seal). The housing seal can be embodied as an O-ring which is accommodated in a corresponding groove of the main body or is embodied as a molded-on seal component. An arrangement of the housing seal in axial configuration is preferred, wherein, particularly preferred, the housing seal surrounds a bayonet connection means which in particular projects in the axial direction. The housing seal can be embodied in particular as a shaped seal with a non-circular cross section, in particular stretched in length direction.

According to a further aspect of the invention, a battery housing, in particular of a traction battery of a motor vehicle, for accommodating battery cells is proposed which comprises at least one housing wall with a housing opening, wherein the housing opening is closed by a degassing unit according to one of the preceding claims.

In particular, mounting of the degassing unit is provided in this context such that it is connected by means of at least one fastening means, in particular a screw, to a wall of the housing, wherein the fastening means is in engagement with the fastening means engagement region of the main body. Due to the screw connection, the required seal pretension forces for compression of the housing seal are produced. The screw connection can be realized in particular from an interior of the electronics housing. Of course, also embodiments of the invention are encompassed in which the screw connection of the degassing unit to the housing is realized from the outer side.

Finally, the housing wall can comprise at an outer side a seal surface surrounding the housing opening at which the housing seal of the degassing unit rests in a mounted state. The seal surface is preferably embodied as a region of the wall of the housing with deviations as minimal as possible with respect to planeness and minimal roughness. Expediently, the housing or at least its wall comprises or is comprised of a metal material so that the seal surface can be obtained with respect to the aforementioned properties simply by mechanical processing.

### BRIEF DESCRIPTION OF DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows a plan view of a degassing unit according to an embodiment of the invention from an inner side.

FIG. 2 shows an exploded illustration of the degassing unit according to FIG. 1.

FIG. 3 shows a cut-away perspective view of the degassing unit according to FIG. 1 from an outer side.

FIG. 4 shows a cut-away perspective view of the degassing unit according to FIG. 1 from the inner side.

FIG. 5 shows an exploded illustration of a membrane of the degassing unit according to an embodiment of the invention.

FIG. 6 shows an exploded illustration of a membrane of the degassing unit according to a further embodiment of the invention.

FIG. 7 shows an exploded illustration of a membrane of the degassing unit according to a further embodiment of the invention.

FIG. 8 shows a cross section through a degassing unit in schematic illustration according to a further embodiment of the invention.

FIG. 9 shows a cross section through a degassing unit in schematic illustration according to a further embodiment of the invention.

FIG. 10 shows a cross section through a degassing unit in schematic illustration according to a further embodiment of the invention.

FIG. 11 shows a cross section through a degassing unit in schematic illustration according to a further embodiment of the invention.

FIG. 12 shows a cross section through a degassing unit in schematic illustration according to a further embodiment of the invention.

FIG. 13 shows a cross section through the degassing unit in schematic illustration according to further embodiment of the invention.

### DETAILED DESCRIPTION

In the Figures, same or same-type components are identified with same reference characters. The Figures show only examples and are not to be understood as limiting.

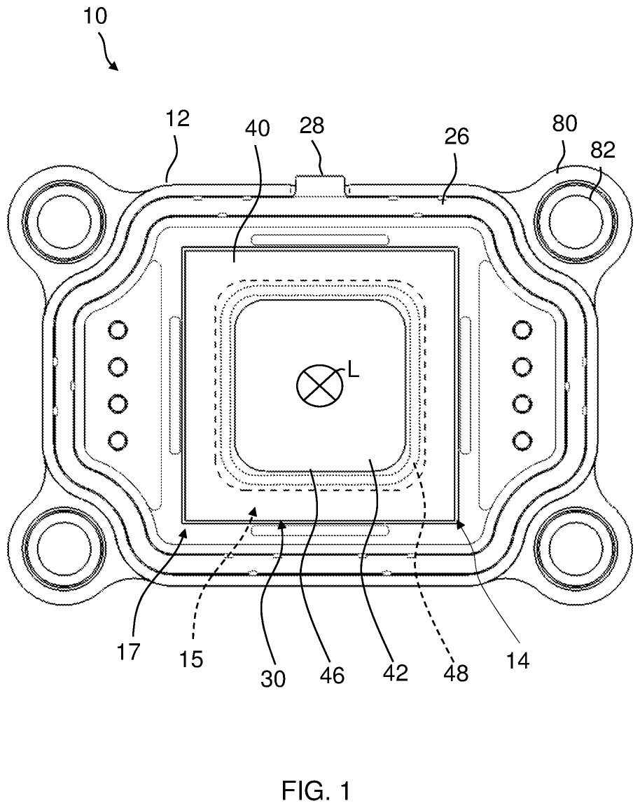

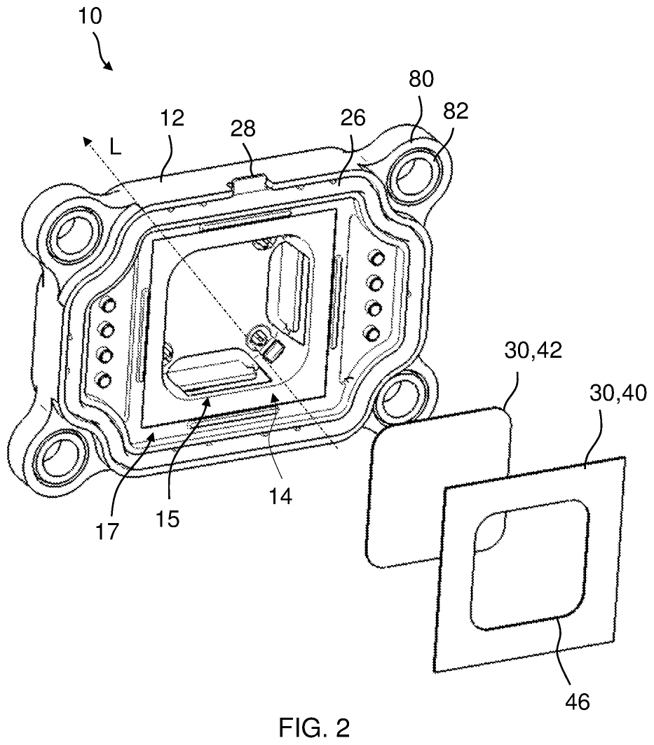

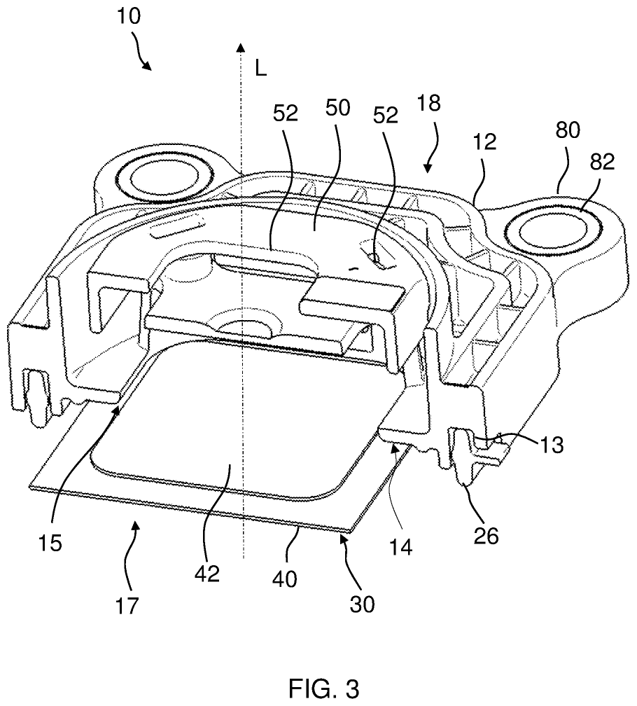

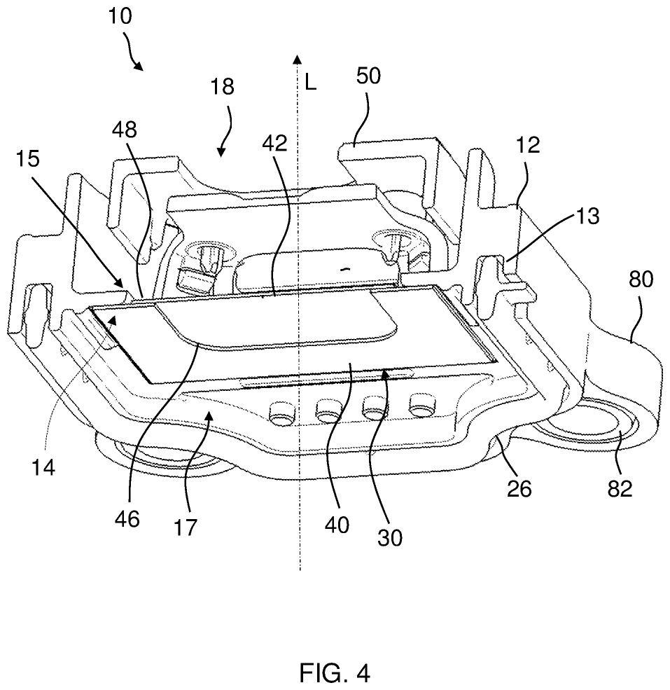

FIG. 1 shows a plan view of a degassing unit 10 according to an embodiment of the invention from an inner side 17, while in FIG. 2 an exploded illustration of the degassing unit 10 and a cut-away perspective illustration from an outer side 18 or from the inner side 17 is illustrated in the FIGS. 3 and 4.

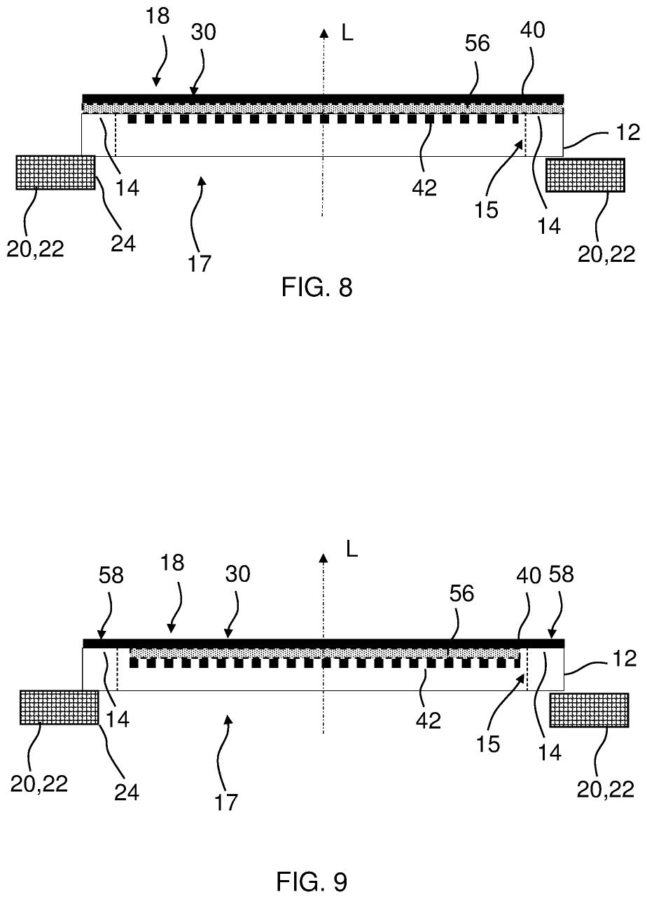

The degassing unit 10 for a battery housing 20, in particular of a traction battery of a motor vehicle, comprises a main body 12 connectable fluid-tightly to a rim of a housing opening 24 of the housing 20 and provided with an outer side 18 and an inner side 17, wherein the inner side 17 is facing toward the housing opening 24 (as can be seen in the schematic cross section in the FIGS. 8 and 9). The main body 12 comprises at least one gas passage opening 15 which is closed by a membrane 30 areally stretched transversely to an axial direction L. The membrane 30 in the illustrated embodiment is arranged perpendicularly to the axial direction L. In principle, the membrane 30 can however also be arranged at an angle to the axial direction L of the degassing unit 10. The membrane 30 is present at the inner side 17 of the main body 12 and is connected fluid-tightly to the main body 12 at a rim 14 surrounding the gas passage opening 15. At least one of the two films 40, 42 of the membrane 30, for example, the first film 40, can be fixedly connected to the main body 12, in particular welded or glued. The gas passage opening 15 is thus completely covered by the membrane 30.

A housing seal 26 which is arranged in a seal groove 13 of the main body 12 is arranged so as to surround the gas passage opening 15 at the inner side 17 of the main body 12. When the degassing unit 10 is mounted at the housing 20, it is possible to check by means of the radially outwardly projecting visible tab 28 whether the housing seal 26 is indeed inserted. The main body 12 can thus be connected to the housing 20 in a gas-tight manner with bolts, not illustrated, in fastening tabs 80 with insertion bushings 82.

The membrane 30 is embodied as a film composite with at least two films 40, 42 arranged on top of each other, wherein a first film 40 of the films 40, 42 in its surface area 44 comprises at least one cutout 46 which is covered by a second film 42 of the films 40, 42 so as to gas-tightly surround the at least one cutout 46. In this context, in the embodiment illustrated in the FIGS. 1 through 4, the first film 40 is connected to the rim 14 of the main body 12 surrounding the gas passage opening 15. The second film 42 is arranged so as to face toward the outer side 18 of the degassing unit 10 and thus of the housing 20. The cutout 46 in the embodiment illustrated in FIG. 1 is embodied with a rectangular shape. The outer rim of the second film 42 is illustrated in dashed lines because it is covered by the first film 40.

The second film 42 is connected to the first film 40 by a seal 48 so as to surround the at least one cutout 46, the seal being illustrated also in dashed lines since the second film 42 and thus also the seal 48 are arranged on the outer side 18. The second film 42 can be heat-fused, welded or glued to the first film 40. The first film 40 can be embodied beneficially of the material of the main body, for example, polypropylene, because the first film 40 is connected to the main body 12, in particular welded; however, other materials can be beneficially used also. The second film 42 can be embodied, for example, as a polymer film, in particular as an elastomer film; however, other materials can be beneficially used also as long as these materials have the suitable stretchability.

The first film 40 comprises advantageously a larger thickness than the second film 42. In particular, the second film 42 can be embodied with a thickness smaller than 0.2 mm, preferably smaller than 0.05 mm, in order to comprise the required stretchability which is required in particular for low degassing pressures.

The first film 40 comprises in this context also advantageously a higher modulus of elasticity than the second film 42, in particular a modulus of elasticity higher by at least 50%. In particular, the second film 42 can comprise a modulus of elasticity smaller than 1,000 MPa, preferably smaller than 500 MPa.

In the exploded illustration of FIG. 2, the construction of the membrane 30 with the two films 40, 42 can be seen, wherein the second film 42 is arranged in the direction toward the outer side on the first film 40 while the first film 40 comprises the cutout 46.

FIGS. 3 and 4 show in the section illustration again the construction of the degassing unit 10. In this context, it can be seen that the membrane 30 is protected toward the outer side 18 from mechanical action by a cover 50 arranged at the main body 12. The cover 50 comprises venting openings 52 toward the outer side 18 through which the outflowing fluid can flow out when the membrane 30 is torn.

In the illustration of FIG. 3, the membrane is illustrated in its entire size while in FIG. 4 the membrane 30 is also sectioned so that the construction of the membrane 30 of the two films 40, 42 can be seen.

In the rim 14 of the gas passage opening 15, the first film 40 is gas-tightly connected to the main body 12 and in particular can be welded thereto.

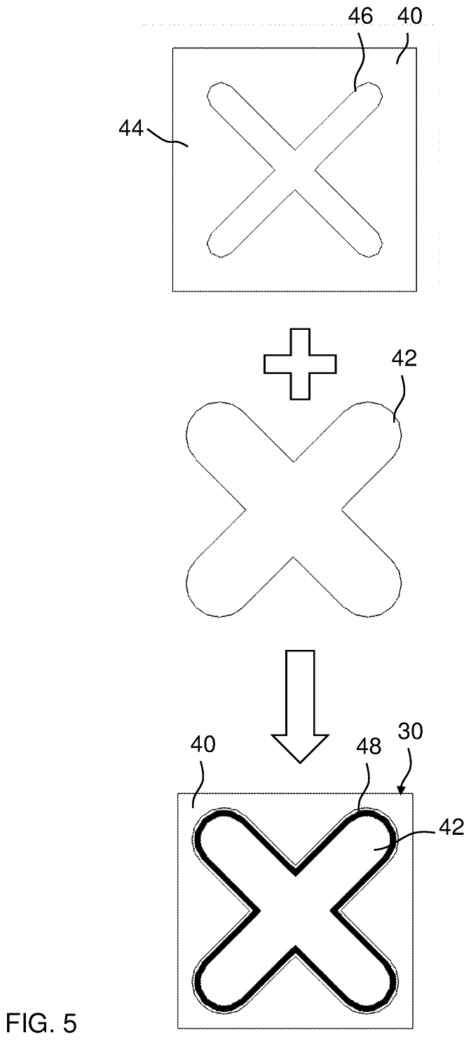

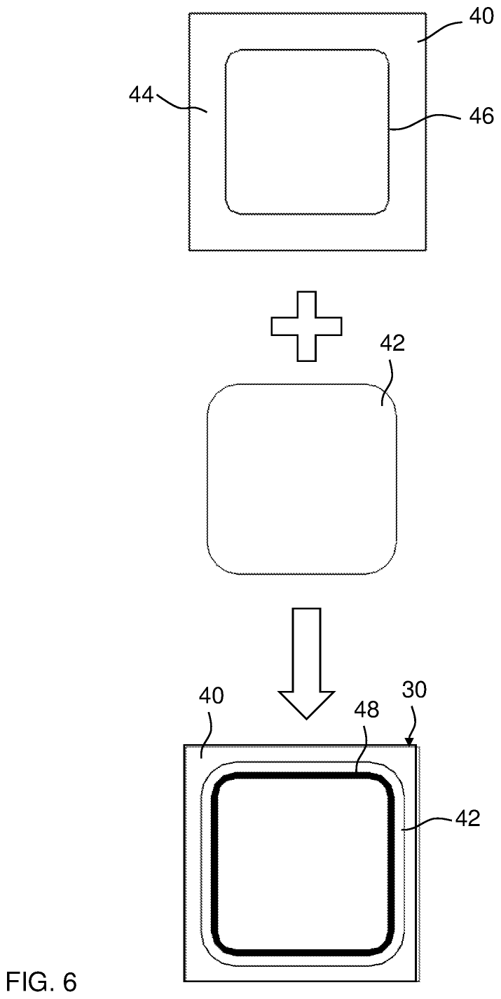

In FIGS. 5 and 6, exploded illustration of a membrane 30 of the degassing unit 10 according to two embodiments of the invention with different cutouts 46 are illustrated.

In FIG. 5, a cross-shaped cutout 46 is illustrated. In this context, the first film 40 comprises a rectangular shape and comprises a diagonally cut-out cross in the surface area 44 of the film 40 as a cutout 46. The second film 42 is also of a cross-shaped configuration but such that, laid across the cutout 46, it closes the cross-shaped cutout 46 with significant overlap.

For forming the complete film composite of the membrane 30 which in FIG. 5 is illustrated in a plan view from the outer side 18 of the degassing unit 10, the second film 42 is tightly connected to the first film 40 in this arrangement by means of the seal 48. In this context, the seal 48 can be formed by heat-fusing, welding or gluing, depending on the material combination. The seal 48 surrounds in this context the cutout 46 at the outer side so that the second film 42 seal-tightly closes the cutout 46.

In the finish-mounted membrane composite, the second film 42 rests on the first film 40 and is connected from this side by means of the seal 48 to the first film 40.

A burst pressure at which the membrane 30 releases the gas passage opening 15 by stretching and tearing of the second film 42 can be adjusted advantageously by means of a width and/or a length and/or a cross section of the seal 48. In this context, the geometry of the seal 48 can be influenced by the adjusted parameters in heat fusing, welding or gluing.

The burst pressure at which the membrane 30 releases the gas passage opening 15 can also be adjusted by the shape and size of the at least one cutout 46 of the first film 40.

In the embodiment illustrated in FIG. 6, the first film 40 comprises a rectangular cutout 46 in the surface area 44 of the film 40 which corresponds to the embodiment illustrated in FIGS. 1 to 4. The second film 42 is also of a rectangular configuration and covers the cutout 46 with significant overlap. The second film 42 is also gas-tightly connected by means of a seal 48 to the first film in the film composite of the membrane 30. The seal 48 surrounds in this context the cutout 46 at the radially outer side.

The membrane 30 in FIG. 6 is illustrated also in a plan view from the outer side 18 of the degassing unit 10 because the second film 42 in this embodiment is arranged preferably so as to face toward the outer side 18.

In the finish-mounted membrane composite, the second film 42 is arranged on the first film 40 and is connected from this side by means of the seal 48 to the first film 40.

The first film 40 and the second film 42 both can advantageously be embodied to be gas-tight when the degassing unit 10 is to be utilized only for release of a possible excess pressure in the housing 20.

Alternatively, only the first film 40 can be embodied to be gas-tight and the second film 42 to be porous when the degassing unit 10 is to be additionally used for pressure compensation. In particular in this context, the second film 42 can be embodied as a semipermeable membrane which enables a passage of gaseous media from an environment into the housing 20 and in reverse and prevents the passage of liquid media and/or solids.

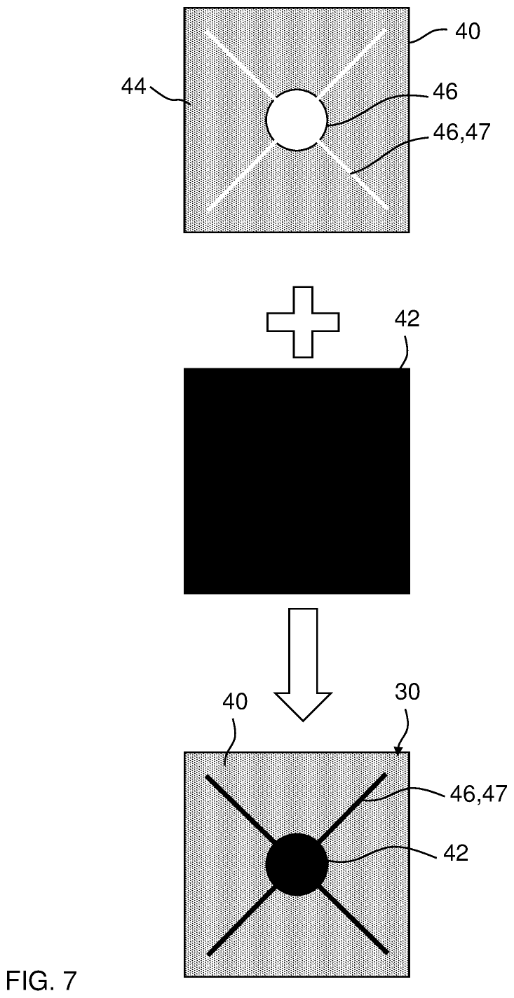

In FIG. 7, an exploded illustration of a membrane 30 of the degassing unit 10 according to a further embodiment of the invention is illustrated.

In this context, the first film 40 comprises a cutout 46 in the surface area 44 which is embodied in a circular shape in the center of the film 40 and comprises diagonally extending slots 47 originating therefrom. The second film 42 is of a rectangular configuration and comprises the same size as the first film 40. In contrast to the illustrations in FIGS. 5 and 6, the second film 42 is however arranged behind the first film 40 in the finish-mounted film composite of the membrane 30 in the plan view in FIG. 7.

The membrane 30 in the embodiment illustrated in FIG. 7 is embodied as a film laminate in which the two films are laminated onto each other, for example, connected by means of an adhesive layer. For example, an adhesive layer 56 can be arranged in this context on one of the two films 40, 42 and glued to the other one of the two films 42, 40.

In this context, the shape of the cutout 46, which is of a circular configuration in the center and comprises diagonally extending slots 47, can be beneficial for low degassing pressures. In this context, the easily stretchable second film 42 stretches through the circular cutout 46 at the center and bulges toward the outer side 18. With increasing excess pressure and/or quickly increasing pressure, the first film to a certain degree can also bulge outwardly due to the slots 47. In this way, the opening of the cutout 46 of the first film 40 is enlarged and the second film 42 can thus stretch still farther outwardly. This can benefit the release of the excess pressure in the interior of the housing 20 upon tearing of the second film 42.

Advantageously, the stretching of the second film 42 can be limited locally by the first film 40. Stretching and tearing of the second film 42 thus takes place preferably in the defined region of the cutout 46 and is substantially limited thereto. At the outer surrounding rim, the film composite can be adhesively connected to the main body 12. The first film 40 can be embodied advantageously of polypropylene for this purpose.

FIG. 8 shows a cross section through a degassing unit 10 in schematic illustration according to a further embodiment of the invention.

The membrane 30 in the embodiment is embodied as a film composite which comprises a first film 40 with an adhesive layer 56 facing toward the inner side 17. The second film 42 is connected thus across its entire surface area by means of the adhesive layer 56 to the first film 40. However, the adhesive layer 56 covers beyond the surface area of the second film 42 the entire surface area of the first film 40 so that the first film 40 can be connected to a rim 14 of the main body 12 by means of the adhesive layer 56. In this way, the entire membrane 30 is seal-tightly glued to the main body 12 because the rim 14 surrounds the gas passage opening 15 of the main body 12 radially outwardly. The gas passage opening 15 is indicated here in dashed lines.

The adhesive layer 56 can be applied directly onto the first film 40. Alternatively, it is also possible that the adhesive layer 56 is embodied as a separate layer, sticky on both sides, which is then connected to the first film 40 and to the second film 42.

The schematically illustrated battery housing 20, in particular of a traction battery of a motor vehicle, which can be configured for accommodating battery cells, can be recognized at least as a housing wall 22 with a housing opening 24. The housing opening 24 is seal-tightly closed in this context by the degassing unit 10.

FIG. 9 shows a cross section through the degassing unit 10 in schematic illustration according to a further embodiment of the invention.

In this embodiment, the adhesive layer 56 of the first film 40 is formed only across the surface area of the second film 42. The adhesive layer 56 can be applied directly onto the first film 40 or the second film 42. Alternatively, it is also possible that the adhesive layer 56 is embodied as a separate layer, sticky on both sides, which then is connected to the first film 40 and to the second film 42.

In this context, the second film 42 is connected also by the adhesive layer 56 to the first film 40. At the rim 14 of the main body 12, the first film 40 however comprises no adhesive layer 56 so that the connection of the first film 40 to the main body 12 can be realized in a different manner, for example, by welding. The first film 40 comprises for this purpose a welding region 58 surrounding the gas passage opening 15 by means of which the first film 40 can be connected to the rim 14 of the main body 12.

In the embodiments illustrated in FIGS. 8 and 9, the more easily stretchable second film 42 is arranged toward the inner side 17 of the degassing unit 10, respectively. As an alternative, the membrane 30 however can also be arranged in the degassing unit 10 such that the second film 42 is oriented toward the outer side 18. Also, in the embodiments illustrated in FIGS. 8 and 9, the first film 40 is connected to the main body 12, respectively. Alternatively, the second film 42 can be connected to the main body 12 also.

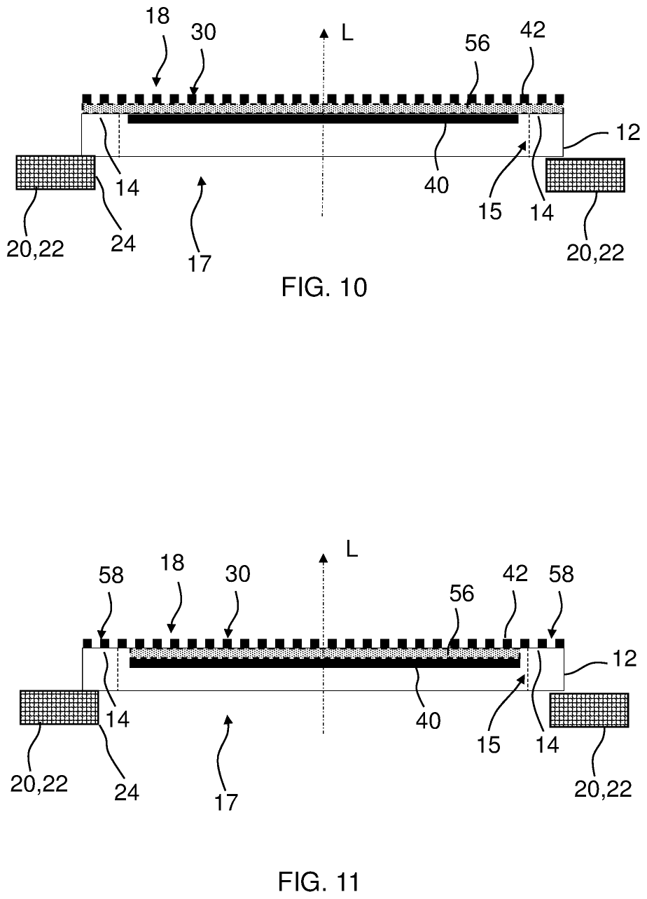

Such embodiments are illustrated in FIGS. 10 and 11. In this context, in FIG. 10 the second film 42 comprises a continuous adhesive layer 56 which is facing toward the inner side 17 and by means of which the film 42 is connected to the rim 14 of the main body 12. The first film 40 is connected across its entire surface area by means of the adhesive layer 56 to the second film 42.

In the embodiment illustrated in FIG. 11, the adhesive layer 56 extends across the surface area of the first film 40. The adhesive layer can be applied to one of the two films 40, 42. In this manner, both films 40, 42 provide a film composite. The second film 42 however comprises a rim projecting past the surface area of the first film 40 which can serve as a welding region 58 for a connection to the rim 14 of the main body 12.

In the embodiments illustrated in FIGS. 8 to 11, the first film 40 or the second film 42 is connected to the main body 12, respectively. Alternatively, also both films 40, 42 can be connected to the main body 12. The membrane 30 embodied as a film laminate can be connected in arbitrary orientation, with the first film 40 toward the outer side 18 or toward the inner side 17, to the main body 12 by means of in particular welding or gluing.

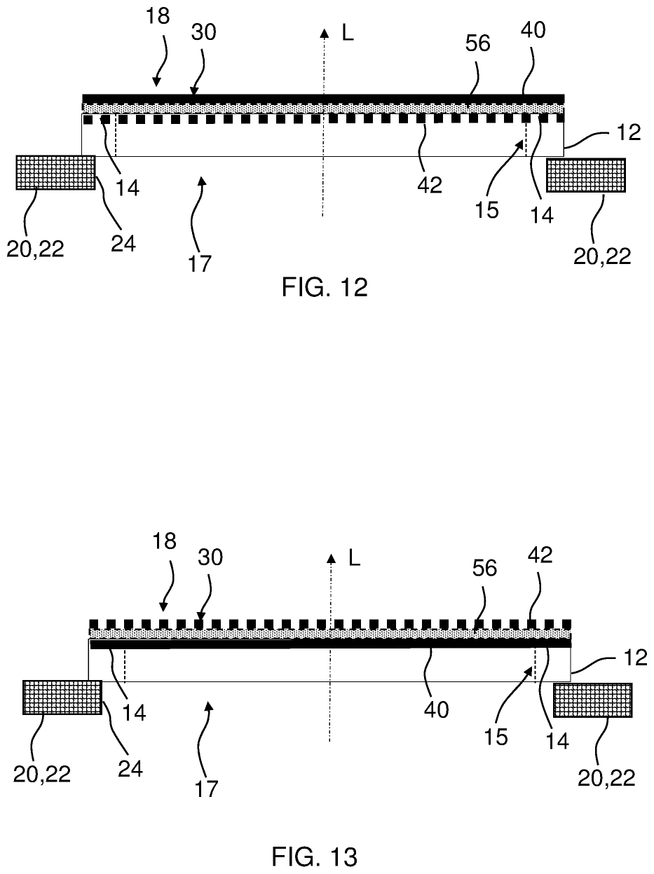

Such embodiments are illustrated in FIGS. 12 and 13. In this context, the membrane 30 represents a film composite in which both films 40, 42 are connected to each other across the entire surface area by means of the adhesive layer 56. In this way, the first film 40 can be facing toward the outer side 18 or the inner side 17, respectively, and the entire film composite can be connected to the rim 14 of the main body 12, respectively.

In the embodiment illustrated in FIG. 12, the first film 40 is facing toward the outer side 18 and the second film 42 toward the inner side 17 and, in the embodiment illustrated in FIG. 13, the second film 42 is facing toward the outer side 18 and the first film 40 is facing toward the inner side 17.

1. A degassing unit for a battery housing, the degassing unit comprising:
a main body configured to be connected fluid-tightly to a rim of a housing opening of the battery housing, the main body comprising:
an outer side and an inner side configured to face in a mounted state toward the housing opening of the battery housing; and
at least one gas passage opening surrounded by a rim of the main body; and
a membrane connected fluid-tightly to the rim of the main body surrounding the at least one gas passage opening, the membrane being areally stretched across the at least one gas passage opening and closing the at least one gas passage opening, and the membrane being configured to burst at a predetermined burst pressure to release the at least one gas passage opening,
wherein the membrane, at least in sections thereof, is a film composite comprising at least a first film and a second film that are arranged on top of each other, the first film comprising in a surface area thereof at least one cutout, the second film covering the at least one cutout to surround the at least one cutout,
wherein at least one of the first film and the second film is connected to the rim of the main body surrounding the at least one gas passage opening, and
wherein the second film is connected to the first film by a seal surrounding the at least one cutout.

2. The degassing unit according to claim 1, wherein the predetermined burst pressure is adjustable by one or more parameters of the seal, the one or more parameters comprising any one or any combination of a width of the seal, a length of the seal, and a cross section of the seal.

3. The degassing unit according to claim 1, wherein the predetermined burst pressure is adjustable by a shape and a size of the at least one cutout.

4. The degassing unit according to claim 1, wherein the second film is configured to face toward the outer side of the main body.

5. The degassing unit according to claim 1, wherein the first film or the second film is connected to the main body and is comprised of a material identical to a material of the main body.

6. The degassing unit according to claim 1, wherein the second film is a polymer film.

7. The degassing unit according to claim 1, wherein the second film is an elastomer film.

8. The degassing unit according to claim 1, further comprising an adhesive layer arranged on the first film and glued to the second film and/or the main body.

9. The degassing unit according to claim 1, further comprising an adhesive layer arranged on the second film and glued to the first film and/or the main body.

10. The degassing unit according to claim 1, wherein the first film comprises a first thickness larger than a second thickness of the second film.

11. The degassing unit according to claim 10, wherein the second thickness is smaller than 0.2 mm.

12. The degassing unit according to claim 1, wherein the first film comprises a first modulus of elasticity higher than a second modulus of elasticity of the second film.

13. The degassing unit according to claim 12, wherein the first modulus of elasticity is higher by at least 50% than the second modulus of elasticity.

14. The degassing unit according to claim 12, wherein the second modulus of elasticity of the second film is smaller than 1,000 MPa.

15. The degassing unit according to claim 1, wherein the at least one cutout is embodied at least in sections in a cross shape or rectangular or circular.

16. The degassing unit according to claim 1, wherein the first film and the second film are gas-tight.

17. The degassing unit according to claim 1, wherein the first film is gas-tight, and
wherein the second film is a semipermeable membrane enabling gaseous media to pass from an environment into the battery housing and in reverse, the semipermeable membrane preventing liquid media and/or solids from passing through.

18. The degassing unit according to claim 1, wherein either one or both of the first film and the second film is fixedly connected to the main body.

19. The degassing unit according to claim 1, further comprising a housing seal arranged at the inner side of the main body and surrounding the at least one gas passage opening.

20. A battery housing configured to accommodate battery cells, the battery housing comprising:
at least one housing wall comprising the housing opening; and
the degassing unit according to claim 1, the degassing unit closing the housing opening.
